(19) United States
(12) Patent Application Publication
(10) Pub. No.: US 2026/0045266 A1
(43) Pub. Date: Feb. 12, 2026

(54) VOICE PARAMETER DETERMINATION METHODS, SYSTEM AND DEVICE

(71) Applicant: INCUBATEUR TECHNOLOGIQUE INOVUM INC., Montréal (CA)

(72) Inventors: Hyejin LEE, Montréal (CA); Ruixi JIANG, Montréal (CA); Jeremy R. COOPERSTOCK, Montréal (CA); Max HENRY, Montréal (CA); Clara DUCHER, Montréal (CA)

(21) Appl. No.: 19/360,874

(22) Filed: Oct. 16, 2025

Related U.S. Application Data
(63) Continuation of application No. 18/310,213, filed on May 1, 2023, now abandoned.

(51) Int. Cl. G10L 21/007; G10L 25/51

(52) U.S. Cl. CPC G10L 21/007; G10L 25/51

(57) ABSTRACT

Methods, device and system for determining a target voice parameters. A location within a 2D search space is assigned to parameterized voices, perceptually similar voices being proximate. Candidate-voices are inserted into a candidate list when a resemblance threshold is reached; A choice between two unmixed voices is received. The plurality of underlying parameters of the unmixed voices are mixed into a mixed voice towards the target-voice. The plurality of underlying parameters from the candidate list are identified. The unadjusted voice is adjusted into an adjusted voice by altering values of the plurality of underlying parameters towards the target-voice. A user interface module receives a choice of a candidate-voice from the 2D search space. An audio playback device plays back at least a portion of the candidate-voice.

### TECHNICAL FIELD

The present invention relates to voice parameter determination and, more particularly, to determining the parameters of a synthetic voice interactively.

### BACKGROUND

Synthetic voices are generally created using training voice samples. A person is recorded reading several sentences covering a wide range of speech characteristics, and the recording is then analyzed using speech analysis techniques that generate voice parameters that can be used to then generate speech outside of the training dataset. The training phase requires interactions with the person whose voice is being parameterized, or at the very least access to voice recordings of the person. This can be problematic when the recordings cannot be obtained. The present disclosure aims at alleviating this obstacle.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the technique described herein relates to a method for, using a plurality of parameterized voices, identifying a plurality of underlying parameters that mimics a target-voice describable by a user. The method comprises assigning a location within a 2D search space to each of the plurality of parameterized voices where perceptually similar voices are proximate. A choice is received of a candidate-voice from the 2D search space. After playing back at least a portion of the chosen candidate-voice, the candidate-voice is inserted in a candidate list comprising one or more candidate-voices upon determining that a resemblance threshold is reached between the chosen candidate-voice and the target-voice. When the resemblance threshold is not reached, the chosen candidate-voice may be discarded. The choosing, the playing back and the inserting may be iteratively repeated until the 2D search space is exhausted or until receiving a decision that the candidate list is complete. The plurality of underlying parameters that mimics a target-voice describable by a user is identified from the candidate list.

Optionally, in addition or alternatively, the method may further comprise receiving a choice of at least two unmixed voices from the candidate list and mixing the underlying parameters of the unmixed voices into a mixed voice towards the target-voice. Optionally, the method may present at least two mixing levels resulting in the mixed voice being a mixture of at least two unmixed voices. A choice of one mixing level resulting in a mixed voice more perceptually similar to the target-voice is then received.

Optionally, in addition or alternatively, the method may further comprise adjusting an unadjusted voice from the candidate-voice into an adjusted voice by altering the values of the unadjusted voice underlying parameters towards the target-voice. Optionally, in addition or alternatively, a plurality of latent parameters associated with qualities of the voice may be presented, each comprising at least one underlying parameter. The unadjusted voice is then adjusted into an adjusted voice by altering the values of the latent parameters towards the target-voice.

In a second aspect, the technique described herein relates to a method for, using at least two parameterized voices, identifying a plurality of underlying parameters that mimics a target-voice describable by a user. The method comprises mixing the underlying parameters of the parameterized voice into a mixed voice towards the target-voice. The plurality of underlying parameters is identified from the mixed voice. Optionally, the method may present at least two mixing levels resulting in the mixed voice being a mixture of at least two unmixed voices. A choice of one mixing level resulting in a mixed voice more perceptually similar to the target-voice is then received.

Optionally, in addition or alternatively, the method may further comprise adjusting an unadjusted voice from the candidate-voice into an adjusted voice by altering the values of the unadjusted voice underlying parameters towards the target-voice. Optionally, in addition or alternatively, a plurality of latent parameters associated with qualities of the voice may be presented, each comprising at least one underlying parameter. The unadjusted voice is then adjusted into an adjusted voice by altering the values of the latent parameters towards the target-voice.

In a third aspect, the technique described herein relates to a method for, using a parameterized voice, identifying a plurality of underlying parameters that mimics a target-voice describable by a user. The method comprises adjusting the parameterized voice into an adjusted voice by altering the values of the parameterized voice underlying parameters towards the target-voice. The plurality of underlying parameters is identified from the adjusted voice.

Optionally, in addition or alternatively, the method may further comprise presenting a plurality of latent parameters associated with qualities of the voice, each comprising at least one underlying parameter. The unadjusted voice is then adjusted into an adjusted voice by altering the values of the latent parameters towards the target-voice.

Optionally, in addition or alternatively, any of the methods may further comprise comparing two parameterized voices by playing them back using an audio playback device comprising at least two channels. The first parameterized voice is played back into a channel of the audio playback device while a second parameterized voice, different from the first, is simultaneously played into a second channel of the audio device. A choice is then received of the parameterized voice that is more perceptually similar to the target-voice.

An aspect of the present invention may relate to a system comprising one or more processors configured to: assign a location within a 2D search space to each of the plurality of parameterized voices, perceptually similar voices being proximate; insert the candidate-voice in a candidate list having one or more candidate-voices upon receiving a determination that a resemblance threshold is reached between the candidate-voice and the target-voice; reject the candidate-voice upon receiving a determination that the resemblance threshold is not reached; receive a choice of at least two unmixed voices from the candidate list; mix the plurality of underlying parameters of the unmixed voices into a mixed voice towards the target-voice; identify the plurality of underlying parameters from the candidate list; and adjust the unadjusted voice from an unadjusted voice chosen from the parameterized voices into an adjusted voice by altering values of the plurality of underlying parameters towards the target-voice. The system also comprises a user interface module configured to receive a choice of a candidate-voice from the 2D search space. The system also comprises an audio playback device, configured to play back at least a portion of the candidate-voice. Other embodiments of this aspect include corresponding computer systems, apparatus, and computer programs recorded on one or more computer storage devices, each configured to perform the actions of the methods.

Optionally, the one or more processors may further be configured to: repeat iteratively the receiving, the playing back and the inserting until: the 2D search space is exhausted; or upon receiving a decision that the candidate list is complete. To achieve the mixing, the one or more processors may further be configured to present at least two mixing levels resulting in the mixed voice being a mixture of at least two unmixed voices and receive a choice of the one mixing level resulting in a mixed voice more perceptually similar to the target-voice. The one or more processors may further be configured to: present a plurality of latent parameters, each having at least one voice parameter, associated with a perceptual quality of the target-voice; and adjust the unadjusted voice into an adjusted voice by altering the values of the latent parameters towards the target-voice. The audio playback device may further be configured to: play back a first parameterized voice into a channel of an audio playback device having at least two channels; simultaneously, play back a second parameterized voice, different from the first parameterized voice, into a second channel of the audio playback device; and the user interface module is further configured to receive a choice of the parameterized voice that is more perceptually similar to the target-voice. Implementations of the described techniques may include hardware, a method or process, or a computer tangible medium.

An aspect of the present invention relates to a device comprising one or more processors configured to: assign a location within a 2D search space to each of the plurality of parameterized voices, perceptually similar voices being proximate; insert the candidate-voice in a candidate list of one or more candidate-voices upon receiving a determination that a resemblance threshold is reached between the candidate-voice and the target-voice; reject the candidate-voice upon receiving a determination that the resemblance threshold is not reached; identify the plurality of underlying parameters from the candidate list of one or more candidate-voices; and mixing the plurality of underlying parameters of the unmixed voices into a mixed voice towards the target-voice. The device also comprises a user interface module configured to: receive a choice of a candidate-voice from the 2D search space; receive a choice of at least two unmixed voices from the candidate list of candidate-voices; and from an unadjusted voice chosen from the parameterized voices, adjusting the unadjusted voice into an adjusted voice by altering values of the plurality of underlying parameters towards the target-voice. An audio playback device is configured to play back at least a portion of the candidate-voice. Other embodiments of this aspect include corresponding computer systems, apparatus, and computer programs recorded on one or more computer storage devices, each configured to perform the actions of the methods.

Optionally, the device may iteratively repeat the receiving, the playing back and the inserting until: the 2D search space is exhausted; or upon receiving a decision that the candidate list is complete. The mixing may be achieved by the user interface module being configured to present at least two mixing levels resulting in the mixed voice being a mixture of at least two unmixed voices and receive a choice of the one mixing level resulting in a mixed voice more perceptually similar to the target-voice. Implementations of the described techniques may include hardware, a method or process, or a computer tangible medium.

### BRIEF DESCRIPTION OF THE DRAWINGS

Further features and exemplary advantages of the present invention will become apparent from the following detailed description, taken in conjunction with the appended drawings, in which:

FIG. 1 is a flow chart depicting an exemplary embodiment in accordance with the teachings of the present invention;

FIG. 2 is a flow chart depicting an exemplary embodiment to obtain a voice candidate from a plurality of parameterized voices in accordance with the teachings of the present invention;

FIG. 3 is a flow chart depicting an exemplary embodiment to obtain a voice candidate from the mixing of two or more parameterized voices in accordance with the teachings of the present invention;

FIG. 4 is a flow chart depicting an exemplary embodiment to obtain a voice candidate from the adjustment of a parameterized voice in accordance with the teachings of the present invention.

FIG. 5 is a logical modular representation of an exemplary system in accordance with the teachings of the present invention.

### DETAILED DESCRIPTION

One aspect of the teachings presented herein relates to an interactive synthetic voice parameter determination method and associated device and system that, in a first set of embodiments, can be used to locate, from within voice samples, the underlying parameters of a synthetic voice that mimics a target-voice describable by a user. For instance, the first set of embodiments may be helpful for auditory psychotherapy including avatar therapy on patients suffering from auditory hallucinations. It is also expected that it can also be helpful in other therapeutic applications that similarly rely on voice stimuli, for example, autism spectrum disorder (ASD), bipolar disorder and post-traumatic stress disorder (PTSD). Other uses of the first set of embodiments may include forensic investigations (e.g., voice reconstruction from witnesses), animated films, video games, virtual agents, etc.

One aspect of the teachings presented herein relates to an interactive synthetic voice parameter determination method and associated device and system that, in a second set of embodiments, can be used to obtain the underlying parameters of a synthetic voice that mimics a target-voice describable by a user by mixing two or more parameterized voice samples. The second set of embodiments may be helpful, for instance, for auditory psychotherapy including avatar therapy on patients suffering from auditory hallucinations. It is expected that the second set of embodiments can also be helpful in other therapeutic applications that similarly rely on voice stimuli, for example, autism spectrum disorder (ASD), bipolar disorder and post-traumatic stress disorder (PTSD). Other uses of the second set of embodiments may include forensic investigations (e.g., voice reconstruction from witnesses), animated films, video games, virtual agents, etc.

One aspect of the teachings presented herein relates to an interactive synthetic voice parameter determination method and associated device and system that, in a third set of embodiments, can be used to obtain the underlying parameters of a synthetic voice that mimics a target-voice describable by a user by adjusting a parameterized voice. The third set of embodiments may be helpful, for instance, for auditory psychotherapy including avatar therapy on patients suffering from auditory hallucinations. It is also expected that the third set of embodiments can also be helpful in other therapeutic applications that similarly rely on voice stimuli, for example, autism spectrum disorder (ASD), bipolar disorder and post-traumatic stress disorder (PTSD). Other uses of the third set of embodiments may include forensic investigations (e.g., voice reconstruction from witnesses), animated films, video games, virtual agents, etc.

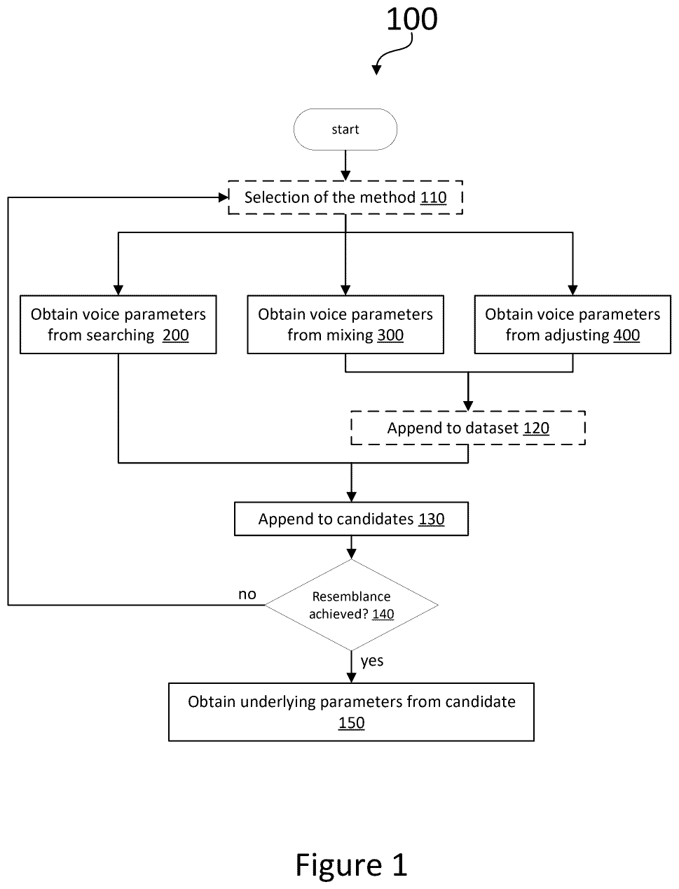

Reference is now made to the drawings in which FIG. 1 shows a flow chart of an exemplary method 100. In certain embodiments, the method 100 starts with a determination 110 of one of three parameters-determination methods 200, 300, 400, which may be used, individually or in various arrangements, to obtain the underlying parameters mimicking the target-voice or follow a predefined sequence. Skilled persons will readily recognize that, in other embodiments, more or less than three parameters-determination methods 200, 300, 400 may be used. For instance, in certain embodiments, only one of the parameters-determination methods 200, 300, 400 may be provided. Furthermore, additionally or alternatively, more than one of the parameters-determination methods 200, 300, 400 may be sequentially arranged (e.g., 200 followed by 400, 300 followed by 200, 300 followed by 400 followed by 300 performed twice followed by 400 etc.) More specifically, the parameters-determination method 200 includes obtaining the voice parameters by searching a plurality of parameterized voices. The parameters-determination method 300 includes obtaining the voice parameters by mixing a plurality of parameterized voices. The parameters-determination method 400 includes obtaining the voice parameters by adjusting a plurality of parameterized voices.

The plurality of parameterized voices is referred to herein as a dataset of parametrized voices or, more shortly, the dataset. FIG. 1 therefore shows an optional selection 110 of one of the parameters-determination methods 200, 300, 400. In the event that the parameters-determination method 300 and/or 400 is performed, once a parameterized voice has been mixed 300 or adjusted 400 a parametrized voice obtained as the result thereof may be inserted 120 to the dataset of the parametrized voices. After the searching 200 or the addition 120 is completed, the result is added 130 to a candidate list of parametrized voices. Upon receiving 140 a determination that the resemblance threshold is reached, the underlying parameters of the voice that mimics a target-voice describable by a user are obtained 150 from the candidate voice. Alternatively, when the resemblance threshold 140 is not reached, the method 100 may iterate back to the optional selection 110.

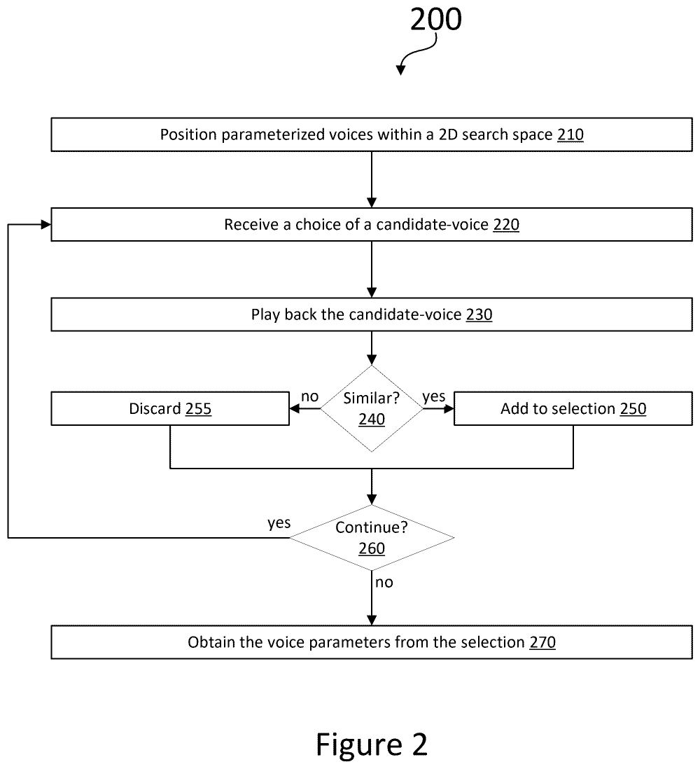

Referring concurrently to FIG. 1 and FIG. 2, the method 200 comprises assigning 210 a location within a 2D search space to each of the plurality of parameterized voices where perceptually similar voices are proximate. In one embodiment, a bank of 2484 existing voice samples may be collected from the LibriSpeech corpus. Using the encoder of a multispeaker text-to-speech (TTS) system, the voices may then be trained into 256 feature vectors from raw waveforms. The TTS encoder may then extract a sequence of log-mel spectrograms from multiple time frames of each audio sample, which may then be provided to a 3-layer long short-term memory (LSTM) network of 768 hidden nodes and a projection of the size 256. The output of the LSTM network is a 256-dimensional vector per time frame, and all these vectors may then be L2 normalized to obtain the speaker embedding that represents the unique timbre of each individual's voice, independent of speech content and background noise. In the exemplary embodiment, the 256 feature vectors may then be projected onto a 2D search space using a Uniform Manifold Approximation Projection (UMAP). In the manifold that results from the UMAP projection, voices presenting similarity end up being proximate to one another, where perceived difference between voices is proportional to the distance between their location in the 2D space. Other dimensionality reduction techniques including Principal Component Analysis (PCA), Locally Linear Embedding (LLE), Isometrics Feature Mapping (Isomap), Multidimensional Scaling (MDS) may alternatively be used to project the high-dimensionality vectors into 2D space. In the exemplary embodiment, when the UMAP is configured for 100 neighbors, two large clusters may naturally emerge grouping male and female voices together and five local clusters within each of these two large clusters may also emerge, representing abstract qualities of the voices such as hoarseness and speaker's age. Color coding may be used to represent each of the main and/or local clusters and further guide the user navigate the 2D space. Additional voice samples may also be provided by the user, analyzed and added in the 2D space, thereby allowing the user to determine an initial area to explore when a voice sample sharing characteristics with the target-voice is available.

A choice is received 220 of a candidate-voice from the 2D search space. The 2D space may for example be presented to a user using a graphical user interface (GUI) and the user may use a mouse as an input device to select a point on the screen using conventional panning and zoom interaction techniques. Skilled persons will readily understand that other types of input devices such as a keyboard or a touch sensitive input device may be used, in additional or alternatively, to receive 220 the choice.

After playing back 230 at least a portion of the chosen candidate-voice, a determination 240 is made as to whether a resemblance threshold is reached between the chosen candidate-voice and the target-voice. In the context of the method 100, the resemblance threshold is defined as a subjective evocation of the target voice. Perceived difference may therefore be tolerated by the user between the target-voice and the selected voice. In some instances, the target voice may only exist in the user's mind. The perceived differences that are determined to be acceptable or inacceptable may therefore depend on a purpose of the method 100. For instance, when the method 100 is used in the context of virtual avatar therapy, the resemblance threshold may generally be met when the patient recognizes the target voice as the one heard in the auditory hallucinations. When the method 100 is used for a simulated voice (e.g., used in a commercial setting), the resemblance threshold may be lower and be met on a subjective judgment of the user as to the age, gender, pitch and other characteristics of the target voice being acceptable.

When the resemblance threshold is reached between the chosen candidate-voice and the target-voice, the candidate-voice is inserted 250 in a candidate list. When the resemblance threshold is not reached, the chosen candidate-voice may be discarded 255. The choosing 220, the playing back 230 and the inserting 250 may be iteratively repeated until the 2D search space is exhausted 260 or until receiving 260 a decision that the candidate list is complete. In an exemplary embodiment, the displayed voices may be played back 230 automatically through speakers or a headset on mouse hover and inserted 250 to the candidate list on mouse click (e.g., to minimize the required user interaction). In an exemplary embodiment, once a parameterized voice is inserted 250 to the candidate list, the user may continue 260, causing the method 200 to receive 220 a choice of at least one more parameterized voice. The candidate voices inserted 250 to the candidate list may further be made available for mixing 300 or adjusting 400.

The plurality of underlying parameters that mimics a target-voice describable by a user is identified from the candidate list. In the exemplary embodiment, the underlying parameters consist of the 256 feature vectors which can then be used in conjunction with a text-to-speech (TTS) tool to produce any output speech in the selected voice. As skilled persons will readily recognize, the selection of the voice from the list from which the underlying parameters are obtained can be achieved in numerous ways, including allowing each voice from the list to be played back until one is selected or sorting the voices in order of preference as they are inserted into the list and choosing the most preferred one.

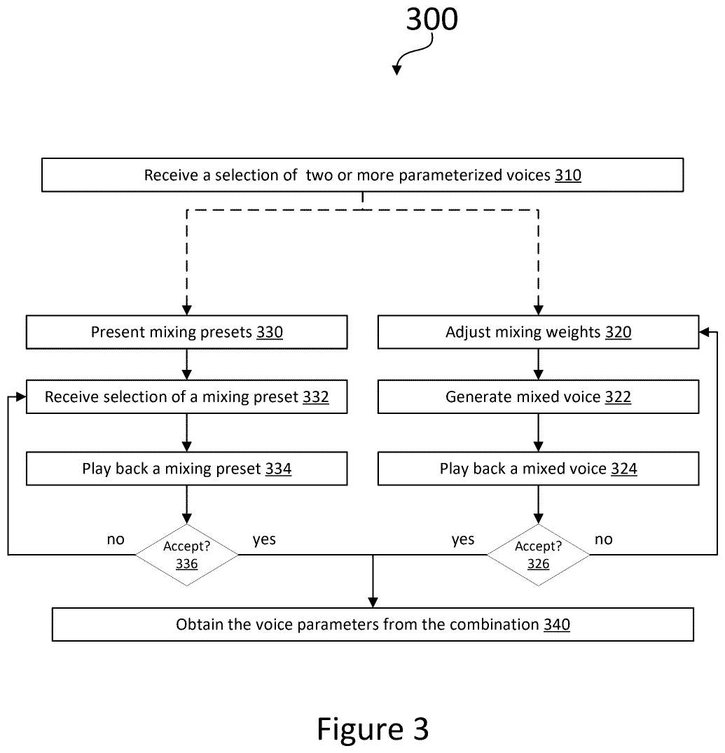

Reference is now concurrently made to FIGS. 1, 2 and 3. Optionally, in addition or alternatively, the method 100 may further be iterated towards the mixing 300, which is further explained hereinbelow with particular reference to FIG. 3.

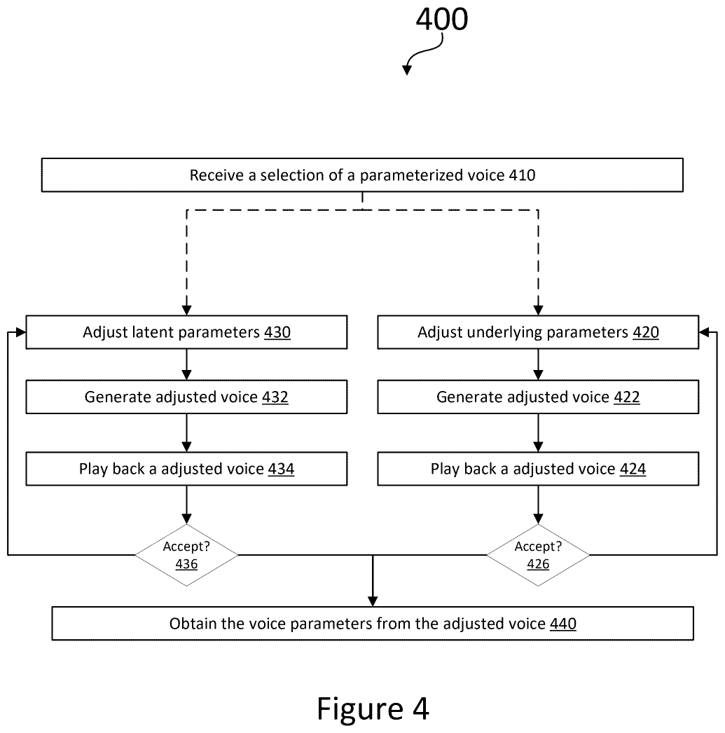

Reference is now concurrently made to FIGS. 1, 2, 3 and 4. Optionally, in addition or alternatively, the method 100 may further be iterated towards the adjusting 400, which is further explained hereinbelow with particular reference to FIG. 4.

As such, the method 100 comprises one or more of the searching 200, the mixing 300 and the adjusting 400, which may be repeated any number of times. As skilled persons will already have understood, an embodiment may, for example, start by searching 200 a voice sample from the 2D space, proceed with adjusting 400 the voice sample, use the adjusted voice as to identify a new area of interest in the 2D search space, identify further voice candidates and mix 300 them with the adjusted sample.

Reference is now concurrently made to FIGS. 1 and 3. In the second set of embodiments, as previously mentioned, an interactive synthetic voice mixing method 300 can be used to obtain the underlying parameters of a synthetic voice that mimics a target-voice describable by a user by mixing two or more parameterized voice samples.

The method 300 comprises receiving 310 a choice of at least two unmixed voices. Following the reception 310 of choice, the method may follow with mixing 320 the underlying parameters of the unmixed voices and generating 322 a mixed voice towards the target-voice. In the exemplary embodiment, the unmixed voices are either provided directly by the user or selected from a voice bank. The unmixed voices could also originate from transformed voices, such as a voice that has been previously mixed or altered using any other techniques. The underlying parameters of the voices may be obtained using the encoder of a multispeaker text-to-speech (TTS) system. The voices may be trained into 256 feature vectors from raw waveforms and then the TTS encoder extracts a sequence of log-mel spectrograms from multiple time frames of each audio sample, which may then be provided to a 3-layer long short-term memory (LSTM) network of 768 hidden nodes and a projection of the size 256. The output of the LSTM network may be a 256-dimensional vector per time frame, and all these vectors may then be L2 normalized to obtain the speaker embedding that represents the unique timbre of each individual's voice, independent of speech content and background noise. The mixing 300 may be performed using linear interpolation between the underlying parameters, but other techniques such as barycentric interpolation may be used when more than two voices are being mixed. All parameters may be interpolated using the same weights, but the mixing 300 of the voice may also be performed on a subset of the underlying parameters, for example on a subset of parameters representing pitch or hoarseness, effectively using one voice as a basis and borrowing specific characteristics from others. After generating 322, the mixed voice is played back 324. Upon receiving a determination 326 that the resemblance threshold is reached, the voice parameters are obtained 340 from the mixed voice. In some embodiments, the resulting mixed voice may be added 130 to a candidate list so that it may be further mixed with other voice samples. When the resemblance threshold is not reached, the mixing weights are further adjusted 320.

Optionally, the method 300 may present 330 at least two mixing levels resulting in the mixed voice being a mixture of at least two unmixed voices. A choice of one mixing level is then received 332. The mixing level is used to generate 334 a mixed voice which is then played back 336. If the mixed voice generated from the mixing preset is accepted 338, the underlying parameters are obtained from the mixed voice. When the mixed voice is not accepted, a new mixing level is selected 332. The mixing levels are predetermined configurations that are presumed to provide interesting mixed voices. Presenting 330 mixing levels may contribute to reduction of the complexity of the operations. Skilled persons will readily recognize that the choice of mixing levels may further comprise a choice for each of the unmixed voices, such that the unmixed voices may still be selected when none of the mixing levels results in a mixed voice more perceptually similar to the target-voice. For instance, in one embodiment, five mixing levels are presented 330 to the user for the mixing of two voices. At the first mixing level, the first voice can be played back without being mixed to the second voice. At the second, third and fourth mixing level, the two voices can be linearly interpolated at 25%, 50% and 75% respectively. At the last level, the second voice can be played back without being mixed to the first voice. It has been shown that presenting 330 five mixing levels may be a compromise between different determinative factors such as distinctiveness of the outputs, computation time to generate the interpolated samples and/or the demand on short-term memory of the user to keep track of the differences between the samples. However, as skilled persons will readily recognize, another number of mixing levels may be determined to be more desirable depending on one or more weights given to different determinative factors.

Reference is now concurrently made to FIGS. 1, 3 and 4. Optionally, in addition or alternatively, the method 300 may further be iterated towards the adjusting 400, which is further explained hereinbelow with particular reference to FIG. 4.

As such, the method 100 comprises one or more of the searching 200, the mixing 300 and the adjusting 400, which may be repeated any number of times. As skilled persons will already have understood, an embodiment may, for example, start by mixing 300 a selection of voice samples, proceed with adjusting 400 the mixed voice sample, use the adjusted voice as to identify a new area of interest in the 2D search space, identify 200 further voice candidates and mix 300 them with the adjusted sample.

Reference is now concurrently made to FIGS. 1 and 4. In the third set of embodiments, as previously mentioned, an interactive synthetic voice adjusting method 400 can be used to obtain the underlying parameters of a synthetic voice that mimics a target-voice describable by a user by adjusting a parameterized voice.

The method 400 comprises receiving 410 a choice of a parameterized voice. In the exemplary embodiment, the parameterized voice is either provided directly by the user or selected from a voice bank. The parameterized voice could also originate from a transformed voice, such as a voice that has been previously mixed or altered using any other techniques. The underlying parameters of the voices may be obtained using the encoder of a multispeaker text-to-speech (TTS) system. The voices may be trained into 256 feature vectors from raw waveforms and then the TTS encoder extracts a sequence of log-mel spectrograms from multiple time frames of each audio sample, which may then be provided to a 3-layer long short-term memory (LSTM) network of 768 hidden nodes and a projection of the size 256. The output of the LSTM network may be a 256-dimensional vector per time frame, and all these vectors may then be L2 normalized to obtain the speaker embedding that represents the unique timbre of each individual's voice, independent of speech content and background noise. Following the reception 410 of choice, the method may follow with adjusting 420 the parameterized voice into an adjusted voice by altering the values, generating 422 an adjusted voice based on the alterations and playing back 424 the adjusted voice. Upon receiving a determination 426 that the resemblance threshold is reached, the plurality of underlying parameters is identified 440 from the adjusted voice. Alternatively, when the resemblance threshold is not reached 426, the underlying parameters may be further adjusted 420.

A plurality of latent parameters may, optionally, in addition or alternatively, be associated with qualities of the voice. Each of the latent parameters comprises at least one underlying parameter. The unadjusted voice may then be adjusted 400 into an adjusted voice by altering 430 the values of the latent parameters towards the target-voice. As such, instead of adjusting 420 the underlying parameters directly, the method 400 may adjust 430 latent parameters comprising a subset of the underlying parameters, each representing one or more underlying parameters. The adjusted voice may then be generated 432 and played back 434. Upon receiving a determination that the resemblance threshold is reached 436, the plurality of underlying parameters may be identified 440 from the adjusted voice. Alternatively, when the resemblance threshold is not reached 436, the latent parameters may be further adjusted 430.

In order to obtain the latent parameters, Principal Component Analysis (PCA) may be used to obtain a subset of the most important underlying parameters. In one embodiment, four main parameters may be identified as latent parameters for having a meaningful impact on four important voice characteristics, namely pitch, resonance, hoarseness and strength/prosody. In a simplified user interface, these exemplary four latent parameters may then be made available for the user to alter the voice. Other embodiments may use different approaches to reduce the dimensionality of the underlying parameters, for example using Singular Value Decomposition (SVD), Non-Negative Matrix Factorization (NMF), Factor Analysis (FA), Linear Discriminant Analysis (LDA), UMAP, t-SNE, etc. Depending on the technique used to reduce the dimensionality, the latent parameters may represent a single underlying parameter or a plurality of them, and a given underlying parameter may be altered by none, one or several latent parameters.

Optionally, in addition or alternatively, any of the embodiments may further comprise comparing (not shown) two parameterized voices by playing them back using an audio playback device comprising at least two channels. The first parameterized voice may be played back into a channel of the audio playback device while a second parameterized voice, different from the first, is simultaneously played into a second channel of the audio device. A choice may then be received of the parameterized voice that is more perceptually similar to the target-voice. The comparing of two voices may be used while navigating the 2D space to compare the selected voice against a reference sample. When mixing voices, the comparing of two voices may be used to compare a mixed voice against a reference sample. When adjusting voices, the comparing of two voices may be used to compare an adjusted voice against a reference sample.

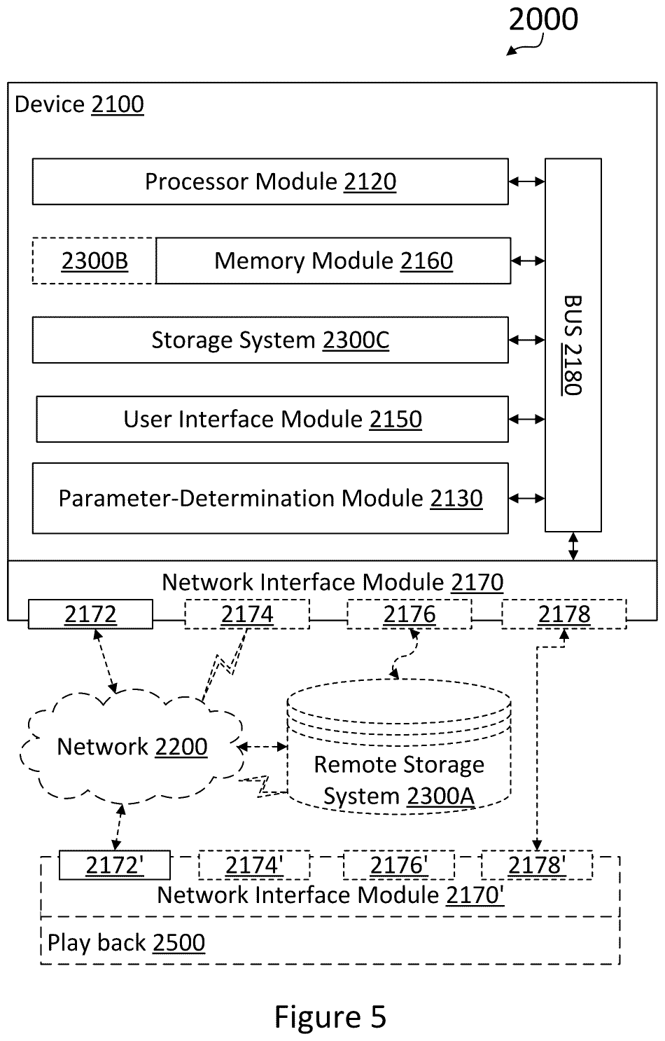

Reference is now made to the drawings in which FIG. 5 shows a logical modular representation of an exemplary system 2000 comprising a device 2100. The device 2100 comprises a memory module 2160, a processor module 2120, a parameter-determination module 2130 and a network interface module 2170. The device 2100 may also include a user interface module 2150.

The system 2000 may comprise a storage system 2300 for storing and accessing long-term (i.e., non-transitory) data and may further log data while the device 2100 is being used. FIG. 5 shows examples of the storage system 2300 as a distinct database system 2300A, a distinct module 2300C of the device 2100 or a sub-module 2300B of the memory module 2160 of the network node 2100. The storage system 2300 may be distributed over different systems A, B, C. The storage system 2300 may comprise one or more logical or physical as well as local or remote hard disk drives (HDD) (or an array thereof). The storage system 2300 may further comprise a local or remote database made accessible to the device 2100 by a standardized or proprietary interface or via the network interface module 2170.

The system 2000 may comprise a play back device 2500 as referred to hereinabove.

The network interface module 2170 represents at least one physical interface that can be used to communicate with other network nodes. The network interface module 2170 may be made visible to the other modules of the device 2100 through one or more logical interfaces. The actual stacks of protocols used by the physical network interface(s) and/or logical network interface(s) 2172-2178 of the network interface module 2170 do not affect the teachings of the present invention.

The processor module 2120 may represent a single processor with one or more processor cores or an array of processors, each comprising one or more processor cores. The memory module 2160 may comprise various types of memory (different standardized or kinds of Random Access Memory (RAM) modules, memory cards, Read-Only Memory (ROM) modules, programmable ROM, etc.).

A bus 2180 is depicted as an example of means for exchanging data between the different modules of the device 2100. The teachings presented herein are not affected by the way the different modules exchange information. For instance, the memory module 2160 and the processor module 2120 could be connected by a parallel bus, but could also be connected by a serial connection or involve an intermediate module (not shown) without affecting the teachings of the present invention.

A parameter-determination module 2130 provides voice parameter-determination-related services to the device 2100 as described in more details hereinabove. More specifically, with reference being concurrently made to FIGS. 1, 2, 3, 4 and 5, the parameter-determination module 2130, the memory module 2160, the user interface module 2150 and/or the processor module 2120 are selectively used to perform the steps 110, 200 (as depicted on FIG. 2), 300 (as depicted on FIG. 3), 400 (as depicted on FIG. 4), 120, 130, 140 and 150.

The variants of processor module 2120, memory module 2160 and network interface module 2170 usable in the context of the present invention will be readily apparent to persons skilled in the art. Likewise, even though explicit mentions of the parameter-determination 2130, the memory module 2160, the user interface module 2150 and/or the processor module 2120 are not made throughout the description of the present examples, persons skilled in the art will readily recognize when such modules are used in conjunction with other modules of the device 2100 to perform routine as well as innovative elements presented herein.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for, using a plurality of parameterized voices, identifying a plurality of underlying parameters that mimics a target-voice describable by a user, the method comprising:
assigning a location within a 2D search space to each of the plurality of parameterized voices, perceptually similar voices being proximate;
receiving a choice of a candidate-voice from the 2D search space;
playing back at least a portion of the chosen candidate-voice;
inserting the chosen candidate-voice in a candidate list comprising one or more candidate-voices upon receiving a determination that a resemblance threshold is reached between the chosen candidate-voice and the target-voice; and
identifying the plurality of underlying parameters from the candidate list.

2. The method of claim 1, further comprising rejecting the chosen candidate-voice upon receiving a determination that the resemblance threshold is not reached.

3. The method of claim 1 or claim 2 further comprising repeating the receiving, the playing back and the inserting until: the 2D search space is exhausted; or upon receiving a decision that the candidate list is complete.

4. The method of claim 3, further comprising:
receiving a choice of at least two unmixed voices from the candidate list; and
mixing the underlying parameters of the unmixed voices into a mixed voice towards the target-voice.

5. The method of claim 4, wherein the mixing is achieved by:
presenting at least two mixing levels resulting in the mixed voice being a mixture of at least two unmixed voices; and
receiving a choice of one mixing level from the at least two mixing levels resulting in a mixed voice more perceptually similar to the target-voice.

6. The method of any one of claim 1 or 5, further comprising:
adjusting the unadjusted voice from a parameterized voice into an adjusted voice by altering the values of the underlying parameters towards the target-voice.

7. The method of claim 6, further comprising:
presenting a plurality of latent parameters, each comprising at least one voice parameter, associated with a perceptual quality of the voice; and
adjusting the unadjusted voice into an adjusted voice by altering the values of the latent parameters towards the target-voice.

8. A method for, using at least two parameterized voices, identifying a plurality of underlying parameters that mimics a target-voice describable by a user, the method comprising:
mixing the underlying parameters of the parameterized voices into a mixed voice towards the target-voice; and
identifying the plurality of underlying parameters from the mixed voice.

9. The method of claim 8, wherein the mixing is achieved by:
presenting at least two mixing levels resulting in the mixed voice being a mixture of at least two unmixed voices; and
receiving a choice of one mixing level from the at least two mixing levels resulting in a mixed voice more perceptually similar to the target-voice.

10. The method of claim 8 or claim 9, further comprising:
adjusting the unadjusted voice from a parameterized voice into an adjusted voice by altering the values of the underlying parameters towards the target-voice.

11. The method of claim 10, further comprising:
presenting a plurality of latent parameters, each comprising at least one voice parameter, associated with qualities of the voice; and
adjusting the unadjusted voice into an adjusted voice by altering the values of the latent parameters towards the target-voice.

12. A method for, using a parameterized voice, identifying a plurality of underlying parameters that mimics a target-voice describable by a user, the method comprising:
adjusting the unadjusted voice from parameterized voice into an adjusted voice by altering the values of the underlying parameters towards the target-voice; and
identifying the plurality of underlying parameters from the adjusted voice.

13. The method of claim 12, further comprising:
presenting a plurality of latent parameters, each comprising at least one voice parameter, associated with a perceptual quality of the voice; and
adjusting the unadjusted voice into an adjusted voice by altering the values of the latent parameters towards the target-voice.

14. The method of any one of claims 1 to 13, wherein two parameterized voices are compared to one another by:
playing back a first parameterized voice into a channel of an audio playback device comprising at least two channels;
playing back a second parameterized voice simultaneously, different from the first, into a second channel of the playback device; and
receiving a choice of the parameterized voice that is more perceptually similar to the target-voice.

15. A system for, using a plurality of parameterized voices, identifying a plurality of underlying parameters that mimics a target-voice describable by a user, comprising:
one or more processors configured to:
assign a location within a 2D search space to each of the plurality of parameterized voices, perceptually similar voices being proximate;
insert the candidate-voice in a candidate list comprising one or more candidate-voices upon receiving a determination that a resemblance threshold is reached between the candidate-voice and the target-voice;
reject the candidate-voice upon receiving a determination that the resemblance threshold is not reached;
receive a choice of at least two unmixed voices from the candidate list;
mix the plurality of underlying parameters of the unmixed voices into a mixed voice towards the target-voice;
identify the plurality of underlying parameters from the candidate list; and
adjust the unadjusted voice from an unadjusted voice chosen from the parameterized voices into an adjusted voice by altering values of the plurality of underlying parameters towards the target-voice;
a user interface module configured to:
receive a choice of a candidate-voice from the 2D search space; and
an audio playback device, configured to:
play back at least a portion of the candidate-voice.

16. The system of claim 15, wherein the one or more processors are further configured to:
repeat iteratively the receiving, the playing back and the inserting until:
the 2D search space is exhausted; or
upon receiving a decision that the candidate list is complete.

17. The system of claim 15 or claim 16, wherein, to achieve the mixing, the one or more processors are further configured to:
presenting at least two mixing levels resulting in the mixed voice being a mixture of at least two unmixed voices; and
receive a choice of one mixing level from the at least two mixing levels resulting in a mixed voice more perceptually similar to the target-voice.

18. The system of any one of claims 15 to 17, wherein the one or more processors are further configured to:
present a plurality of latent parameters, each comprising at least one voice parameter, associated with a perceptual quality of the target-voice; and
adjust the unadjusted voice into an adjusted voice by altering the values of the latent parameters towards the target-voice.

19. The system of claims 15 to 18, wherein:
the audio playback device is further configured to:
play back a first parameterized voice into a channel of an audio playback device comprising at least two channels;
simultaneously, play back a second parameterized voice, different from the first parameterized voice, into a second channel of the audio playback device; and
the user interface module is further configured to:
receive a choice of the parameterized voice that is more perceptually similar to the target-voice.

20. A device for, using a plurality of parameterized voices, identifying a plurality of underlying parameters that mimics a target-voice describable by a user, comprising:
one or more processors configured to:
assign a location within a 2D search space to each of the plurality of parameterized voices, perceptually similar voices being proximate;
insert the candidate-voice in a candidate list of one or more candidate-voices upon receiving a determination that a resemblance threshold is reached between the candidate-voice and the target-voice;
reject the candidate-voice upon receiving a determination that the resemblance threshold is not reached;
identify the plurality of underlying parameters from the candidate list of one or more candidate-voices; and
mixing the plurality of underlying parameters of the unmixed voices into a mixed voice towards the target-voice; and
a user interface module configured to:
receive a choice of a candidate-voice from the 2D search space;
receive a choice of at least two unmixed voices from the candidate list of candidate-voices; and
from an unadjusted voice chosen from the parameterized voices, adjust the unadjusted voice into an adjusted voice by altering values of the plurality of underlying parameters towards the target-voice;
wherein an audio playback device is configured to play back at least a portion of the candidate-voice.

21. The device of claim 20 further comprising iteratively repeating the receiving, the playing back and the inserting until:
the 2D search space is exhausted;
or upon receiving a decision that the candidate list is complete.

22. The device of claim 20, or claim 21 wherein the mixing is achieved by the user interface module being configured to:
present at least two mixing levels resulting in the mixed voice being a mixture of at least two unmixed voices; and
receive a choice of one mixing level from the at least two mixing levels resulting in a mixed voice more perceptually similar to the target-voice.

23. The device of any one of claims 20 to 22, wherein the user interface module is further configured to:
present a plurality of latent parameters, each comprising at least one voice parameter, associated with a perceptual quality of the target-voice; and
adjust the unadjusted voice into an adjusted voice by altering the values of the latent parameters towards the target-voice.
